(19) United States
(12) Patent Application Publication
(10) Pub. No.: US 2026/0044373 A1
(43) Pub. Date: Feb. 12, 2026

(54) SYSTEMS, APPARATUSES, METHODS, AND COMPUTER PROGRAM PRODUCTS FOR RESOURCE ALLOCATION OPTIMIZATION

(71) Applicant: Honeywell International Inc., Charlotte, NC (US)

(72) Inventors: Sunil Anthon Bardeskar, Bangalore (IN); Chandrashekar V Srinivas, Bangalore (IN); Ananda Vel Murugan Chandra Mohan, Madurai (IN); Ivan Borastero Villan, St Germaine-en-Laye (FR)

(21) Appl. No.: 18/912,293

(22) Filed: Oct. 10, 2024

(30) Foreign Application Priority Data
Aug. 9, 2024 (IN) 202411060335

(51) Int. Cl. G06F 9/50

(52) U.S. Cl. CPC G06F 9/5005

(57) ABSTRACT

Embodiments of the present disclosure provide optimized resource allocation. Resource data associated with a plurality of items may be identified. Item similarity prediction data may be generated by applying the resource data to an item matching machine learning model. The item similarity prediction data may comprise at least one predicted similar items subset from the plurality of items. The at least one predicted similar items subset may comprise at least one target item from the plurality of items and one or more similar items from the plurality of items. Item feature data associated with the at least one predicted similar items subset may be identified via one or more external sources. Optimization data may be generated by analyzing the item similarity prediction data with respect to the item feature data. The optimization data may comprise an optimal similar item selected from the one or more similar items.

### CROSS REFERENCE TO RELATED APPLICATIONS

The present application claims the benefit of India Provisional Application No. 202411060335 filed August 9, 2024, and titled “SYSTEMS, APPARATUSES, METHODS, AND COMPUTER PROGRAM PRODUCTS FOR INTELLIGENT INVENTORY OPTIMIZATION,” which is hereby incorporated by reference in its entirety.

### TECHNICAL FIELD

The present disclosure relates, generally, to resource management. Example embodiments provide systems, apparatuses, methods, and computer program products for resource allocation optimization.

### BACKGROUND

Applicant has discovered problems associated with resource allocation. Through applied effort, ingenuity, and innovation, Applicant has solved many of these identified problems by developing solutions embodied in the present disclosure, which are described in detail below.

### BRIEF SUMMARY

Example embodiments provide systems, apparatuses, methods, and computer program products for resource allocation optimization.

In accordance with one aspect of the present disclosure, a computer-implemented method is provided. The computer-implemented method is executable using any of a myriad of computing device(s) and/or combinations of hardware, software, and/or firmware. In some example embodiments, an example computer-implemented method includes identifying, by one or more processors, resource data associated with a plurality of items; generating, by the one or more processors, item similarity prediction data based on the resource data by applying the resource data to an item matching machine learning model, wherein the item similarity prediction data comprises at least one predicted similar items subset from the plurality of items, and wherein the at least one predicted similar items subset comprises at least one target item from the plurality of items and one or more similar items from the plurality of items; identifying, by the one or more processors, item feature data associated with the at least one predicted similar items subset via one or more external sources; generating, by the one or more processors, based on the item similarity prediction data and the item feature data, optimization data by analyzing the item similarity prediction data with respect to the item feature data, wherein the optimization data comprises an optimal similar item selected from the one or more similar items; and initiating, by the one or more processor, performance of one or more optimized resource allocation actions in response to generation of the optimization data.

In some embodiments, at least one of the plurality of items are associated with a plurality of facility locations, wherein the at least one target item is associated with a first facility location from the plurality of facility locations and the optimal similar item is associated with a second facility from the plurality of facility locations.

In some embodiments, the at least one target item is associated with a first item utilization status; and the optimal similar item is associated with a second item utilization status.

In some embodiments, generating the optimization data comprises applying the feature data and the item similarity prediction data to a resource allocation optimization machine learning model.

In some embodiments, the feature data comprises one or more of (i) technical characteristics, (ii) demand data, or (ii) obsolescence data.

In some embodiments, applying the resource data to the item matching machine learning model comprises inputting the resource data to the item matching machine learning model, wherein the item matching machine learning model is configured to perform fuzzy similarity-based matching operation on the resource data to generate the resource data; and obtaining the item similarity prediction data from the item matching machine learning model.

In some embodiments, initiating the performance of the one or more optimized resource allocation actions comprises causing item design data associated with a related item that includes the similar optimal item to be modified.

In some embodiments, modifying the item design data includes replacing the optimal similar item with the at least one target item in the item design data.

In some embodiments, initiating the performance of the one or more optimized resource allocation actions comprises generating a resource allocation optimization interface component, wherein the resource allocation optimization interface component comprises one or more of data associated with the at least one target item and the optimal similar item.

In accordance with another aspect of the present disclosure, an apparatus is provided. The apparatus in some embodiments includes at least one processor and at least one non-transitory memory, the at least one non-transitory memory having computer-coded instructions stored thereon. The computer-coded instructions in execution with the at least one processor causes the apparatus to perform any of the example computer-implemented methods described herein. In some other embodiments, the apparatus includes means for performing each step of any of the computer-implemented methods described herein.

In accordance with another aspect of the present disclosure, a computer program product is provided. The computer program product in some embodiments includes at least one non-transitory computer-readable storage medium having computer program code stored thereon. The computer program code in execution with at least one processor is configured for performing any one or the example computer-implemented methods described herein.

### BRIEF DESCRIPTION OF THE SEVERAL VIEWS OF THE DRAWINGS

Having thus described the embodiments of the disclosure in general terms, reference now will be made to the accompanying drawings, which are not necessarily drawn to scale, and wherein:

FIG. 1 illustrates a block diagram of an example system architecture in which embodiments of the present disclosure may operate.

FIG. 2 illustrates a block diagram of an example apparatus in accordance with at least one example embodiment of the present disclosure.

FIG. 3a and FIG. 3b each example visualization of data structures, modules, and processes for optimized resource allocation in accordance with at least one example embodiment of the present disclosure.

FIG. 4 illustrates an example resource allocation optimization interface in accordance with at least one example embodiment of the present disclosure.

FIG. 5 illustrates a flowchart for optimized resource allocation in accordance with at least one example embodiment of the present disclosure.

### DETAILED DESCRIPTION

Various embodiments of the present disclosure now will be described more fully hereinafter with reference to the accompanying drawings, in which some, but not all, embodiments of the present disclosure are shown. Indeed, the present disclosure may be embodied in many different forms and should not be construed as limited to the embodiments set forth herein, rather, these embodiments are provided so that this disclosure will satisfy applicable legal requirements.

The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not indicate being based only on or based solely on the referenced element or elements unless so indicated. Like numbers refer to like elements throughout.

### OVERVIEW AND TECHNICAL IMPROVEMENTS

Example embodiments disclosed herein address technical problems associated with resource allocation for a system, particularly for a system associated with a large number of items and which may be utilized in multiple facilities. As would be understood by one skilled in the field to which this disclosure pertains, there are numerous example scenarios in which systems, apparatuses, methods, and computer program products for optimized resource allocation are desirable.

In many applications, it may be desirable to use systems, apparatuses, methods, and computer program products for resource allocation optimization. For example, it may be desirable to use systems, apparatuses, methods, and computer program products for resource allocation optimization to identify similar items and reallocate items such that items are more efficiently utilized across the system. In some implementations, it may be desirable to use systems, apparatuses, methods, and computer program products that are configured to perform resource allocation optimization using one or more artificial intelligence/machine learning model (AI/ML).

Example solutions for resource allocation for a system is cumbersome, involves attempting to analyze large among of design data and resource data. However, such example solutions are inefficient, time consuming, inaccurate, and incapable of accounting for dynamic resource utilization. For example, such example solutions are inefficient because such example solutions do not use a machine learning model framework that includes a plurality of specifically configured model for performing particular aspects of resource allocation optimization. As a result, such example solutions cause computing devices to suffer from high latency, consume excessive processing power, and consume excessive memory. As another example, such example solutions are reactive because such example solutions are unable to automatically implement optimized resource allocation actions.

In this regard, such example solutions are unable to automatically implement optimized resource allocation actions that automatically cause items to be optimally reallocated, item design data to be modified, item manufacturing procedures to be modified and/or resource records to be modified. Accordingly, there is a need for systems, apparatuses, methods, and computer program products that are able to perform resource allocation in an efficient, accurate, and effective manner.

Thus, to address these and/or other issues related to resource allocation for a system, example systems, apparatuses, methods, and computer program products for resource allocation optimization are disclosed herein. For example, an embodiment in this disclosure, described in greater detail below, includes a method that includes identifying resource data associated with a plurality of items associated with an external system. In some embodiments, the method includes generating item similarity prediction data by applying the resource data to an item matching machine learning model, the similarity prediction data including at least one predicted similar items subset from the plurality of items, and the predicted similar items subset including at least one target item from the plurality of items and one or more similar items from the plurality of items. In some embodiments, the method includes identifying item feature data associated with at least one predicted similar items subset via one or more external sources. In some embodiments, the method includes generating optimization data by analyzing similarity prediction data with respect to item feature data, the optimization data including an optimal similar item selected from the one or more similar items. In some embodiments, the method includes initiating performance of one or more optimized resource allocation actions in response to generation of the optimization data. Accordingly, the systems, apparatuses, methods, and computer program products enable resource allocation optimization in an efficient, accurate, and effective manner.

### DEFINITIONS

Many modifications and other embodiments of the disclosure set forth herein will come to mind to one skilled in the art to which this disclosure pertains having the benefit of the teachings presented in the foregoing description and the associated drawings. Therefore, it is to be understood that the embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

As used herein, the terms “data,” “content,” “digital content,” “information,” and similar terms may be used interchangeably to refer to data capable of being transmitted, received, and/or stored in accordance with embodiments of the present disclosure. Further, where a computing entity is described herein to receive data from another computing entity, it will be appreciated that the data may be received directly from another computing entity or may be received indirectly via one or more intermediary computing entities, such as, for example, one or more servers, relays, routers, network access points, base stations, hosts, and/or the like, sometimes referred to herein as a “network.” Similarly, where a computing entity is described herein to send data to another computing device, it will be appreciated that the data may be sent directly to another computing entity or may be sent indirectly via one or more intermediary computing devices, such as, for example, one or more servers, relays, routers, network access points, base stations, hosts, and/or the like.

### EXAMPLE SYSTEMS AND APPARATUSES OF THE DISCLOSURE

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

A non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

A volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

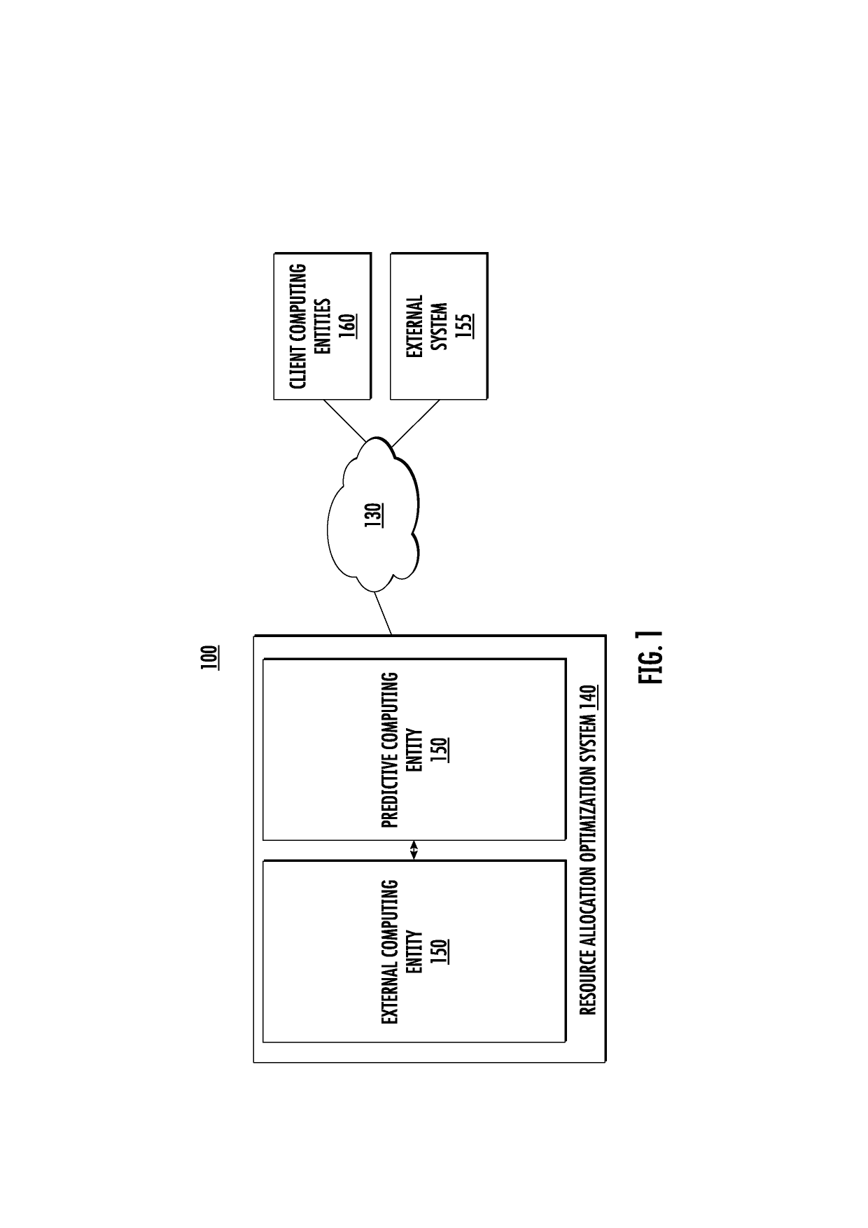

In this regard, FIG. 1 provides an example overview of a system architecture 100 in accordance with at least some example embodiments of the present disclosure. The depiction of the example architecture 100 is not intended to limit or otherwise confine the embodiments described and contemplated herein to any particular configuration of elements or systems, nor is it intended to exclude any alternative configurations or systems for the set of configurations and systems that can be used in connection with embodiments of the present disclosure. Rather, FIG. 1 and the architecture 100 disclosed therein is merely presented to provide an example basis and context for the facilitation of some of the features, aspects, and uses of the methods, apparatuses, computer readable media, and computer program products disclosed and contemplated herein. It will be understood that while many of the aspects and components presented inFIG. 1 are shown as discrete, separate elements, other configurations may be used in connection with the methods, apparatuses, computer readable media, and computer programs described herein, including configurations that combine, omit, separate, and/or add aspects and/or components. The example system architecture 100 may be used in a plurality of domains and not limited to any specific application as disclosed herewith. In particular, while some example embodiments are described herein with reference to particular domain, the example system architecture 100 may be used in a plurality of domains and limited to any specific application as disclosed herein. The plurality of domains may include healthcare, industrial, manufacturing, education, retail, to name a few.

As illustrated, the system architecture 100 includes a resource allocation optimization system 140 configured to receive requests from client computing entities 160, process the requests to generate predictive outputs, and provide the predictive output to the client computing entities 160. In various embodiments, such predictive outputs may include optimal resource allocation data for an external system . In some embodiments at least one of the client computing entities 160 is associated with the external system.

In some embodiments, the external system 155 includes any number of computing device(s), system(s), physical component(s), and/or the like, that facilitates producing of any number of items, for example utilizing particular configurations that cause processing of particular inputs available within the external system 155. In some embodiments, the external system 155 includes one or more physical component(s), connection(s) between physical component(s), and/or computing system(s) that control operation of each physical component therein. Alternatively or additionally, in some embodiments the external system 155 includes one or more computing system(s) that are specially configured to operate the physical component(s) in a manner that produces one or more particular items(s) simultaneously. In some embodiments, external system 155 includes one or more computing device(s) and/or system(s) embodied in hardware, software, firmware, and/or a combination thereof, that configure and/or otherwise control operation of one or more physical component(s) in the manufacturing plant (e.g., processing plant, assembling plant, and/or the like). For example, in some embodiments, such computing device(s) and/or system(s) include one or more programmable logic controller(s), MPC(s), application server(s), centralized control system(s), and/or the like, that control(s) configuration and/or operation of at least one physical component. It will be appreciated that different external system 155 may include different physical component(s), computing system(s), and/or the like.

In some embodiments, the external system 155 is associated with one or more facilities. A non-limiting example of a facility is a manufacturing plant (e.g., processing plant, assembling plant, or the like). Such manufacturing plant may be referred to herein as plant. In some embodiments, each facility may represent one or more processing plants (or one or more portions thereof), such as one or more manufacturing plants for producing at least one item.

The example architecture 100 may be used in a plurality of domains and not limited to any specific application as disclosed herewith. The plurality of domains may include healthcare, industrial, manufacturing, education, retail, to name a few.

In some embodiments, the resource allocation optimization system 140 may communicate with at least one of the client computing entities 160 and/or external system 155 using one or more communication networks, for example a communications network 130. As described above, in some embodiments, at least one of the client computing entities 160 is associated with the external system 155 and may be leveraged by the external system 155 to communicate with the resource allocation optimization system 140. The resource allocation optimization system 140 may include a predictive computing entity 110 configured to receive requests from client computing entities 160, process the requests to generate predictive outputs, and provide the predictive output to the client computing entities 160. In various embodiments, such predictive outputs include optimal resource allocation data.

It should be appreciated that the communications network 130 in some embodiments is embodied in any of a myriad of network configurations. In some embodiments, the communications network 130 embodies a public network (e.g., the Internet). In some embodiments, the communications network 130 embodies a private network (e.g., an internal localized, or closed-off network between particular devices). In some other embodiments, the communications network 130 embodies a hybrid network (e.g., a network enabling internal communications between particular connected devices and external communications with other devices). The communications network 130 in some embodiments includes one or more base station(s), relay(s), router(s), switch(es), cell tower(s), communications cable(s) and/or associated routing station(s), and/or the like. In some embodiments, the communications network 130 includes one or more user-controlled computing device(s) (e.g., a user owned router and/or modem) and/or one or more external utility devices (e.g., Internet service provider communication tower(s) and/or other device(s)).

Each of the components of the system architecture 100 may be communicatively coupled to transmit data to and/or receive data from one another over the same or different wireless and/or wired networks embodying the communications network 130. Such configuration(s) include, without limitation, a wired or wireless Personal Area Network (PAN), Local Area Network (LAN), Metropolitan Area Network (MAN), Wide Area Network (WAN), and/or the like. Additionally, while FIG. 1 illustrate certain system entities as separate, standalone entities communicating over the communications network 130, the various embodiments are not limited to this architecture. In other embodiments, one or more computing entities share one or more components, hardware, and/or the like, or otherwise are embodied by a single computing device such that connection(s) between the computing entities are over the communications network 130 are altered and/or rendered unnecessary.

In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein.

In some embodiments, client computing entities 160 may be operated by various parties. In some embodiments, the client computing entity 160 may include an antenna, a transmitter (e.g., radio), a receiver (e.g., radio), and a processing element (e.g., CPLDs, microprocessors, multi-core processors, coprocessing entities, ASIPs, microcontrollers, and/or controllers) that provides signals to and receives signals from the transmitter and receiver, correspondingly. The client computing entity 160 may also comprise a user interface (that may include an output device (e.g., display, speaker, tactile instrument, etc.) coupled to a processing element) and/or a user input interface (coupled to a processing element). For example, the user interface may be a user application, browser, user interface, and/or similar words used herein interchangeably executing on and/or accessible via the client computing entity 160 to interact with and/or cause display of information/data from another computing entity, as described herein. The user input interface may comprise any of a plurality of input devices (or interfaces) allowing the client computing entity 160 to receive code and/or data, such as a keypad (hard or soft), a touch display, voice/speech or motion interfaces, or other input device. The client computing entity 160 may also include volatile memory and/or non-volatile memory, which may be embedded and/or may be removable.

In some embodiments, the predictive computing entity 110 may include, or be in communication with, one or more processing elements (also referred to as processors, processing circuitry, and/or similar terms used herein interchangeably) that communicate with other elements within the predictive computing entity 110 via a bus, for example. As will be understood, the processing element may be embodied in a number of different ways.

For example, the processing element may be embodied as one or more complex programmable logic devices (CPLDs), microprocessors, multi-core processors, coprocessing entities, application-specific instruction-set processors (ASIPs), microcontrollers, and/or controllers. Further, the processing element may be embodied as one or more other processing devices or circuitry. The term circuitry may refer to an entirely hardware embodiment or a combination of hardware and computer program products. Thus, the processing element may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element may be configured for a particular use or configured to execute instructions stored in volatile or non-volatile media or otherwise accessible to the processing element. As such, whether configured by hardware or computer program products, or by a combination thereof, the processing element may be capable of performing steps or operations according to embodiments of the present disclosure when configured accordingly.

In some embodiments, the predictive computing entity 110 may further include, or be in communication with, non-volatile media (also referred to as non-volatile storage, memory, memory storage, memory circuitry, and/or similar terms used herein interchangeably). The non-volatile media may store databases, database instances, database management systems, data, applications, programs, program modules, scripts, code (e.g., source code, object code, byte code, compiled code, interpreted code, machine code, etc.) that embodies one or more machine learning models or other computer functions described herein, executable instructions, and/or the like. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In some embodiments, the predictive computing entity 110 may further include, or be in communication with volatile media (also referred to as volatile storage, memory, memory storage, memory circuitry, and/or similar terms used herein interchangeably). The volatile storage or memory media may be used to store at least portions of the databases, database instances, database management systems, data, applications, programs, program modules, code (source code, object code, byte code, compiled code, interpreted code, machine code) that embodies one or more machine learning models or other computer functions described herein, executable instructions, and/or the like being executed by, for example, the processing element. Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the predictive computing entity 110 with the assistance of the processing element and operating system.

In some embodiments, the predictive computing entity 110 may also include one or more network interfaces for communicating with various computing entities (e.g., the client computing entity 160, external computing entities, etc.), such as by communicating data, code, content, information, and/or similar terms used herein interchangeably that may be transmitted, received, operated on, processed, displayed, stored, and/or the like. Such communication may be executed using a wired data transmission protocol. In some embodiments, the predictive computing entity 110 communicates with another computing entity for uploading or downloading data or code (e.g., data or code that embodies or is otherwise associated with one or more machine learning models). Similarly, the predictive computing entity 110 may be configured to communicate via wireless external communication networks using any of a variety of protocols.

The predictive computing entity 110 may include, or be in communication with, one or more input elements, such as a keyboard input, a mouse input, a touch screen/display input, motion input, movement input, audio input, pointing device input, joystick input, keypad input, and/or the like. The predictive computing entity 110 may also include, or be in communication with, one or more output elements (not shown), such as audio output, video output, screen/display output, motion output, movement output, and/or the like.

In some embodiments, the predictive computing entity 110 may train and use one or more machine learning models described herein. In other embodiments, the predictive computing entity may use one or more machine learning models that may be trained by a second computing entity (e.g., external computing entity 150) communicatively coupled to the predictive computing entity. The second computing entity, for example, may train one or more of the machine learning models described herein, and subsequently provide the trained machine learning model(s) (e.g., optimized weights, code sets, etc.) to the predictive computing entity over a network.

As described above, the predictive computing entity 110 may leverage one or more AI/ML models to perform and/or facilitate performance of one or more operations associated with resource allocation optimization according to one or more techniques described herein. For example, the predictive computing entity 110 may include or is otherwise associated with one or more AI/ML models configured to perform and/or facilitate performance of one or more operations associated with resource allocation optimization as described herein. Such operations may include predictive data analysis, image analysis, resource allocation optimization, and/or other operations according to techniques described herein. The predictive computing entity 110 may be configured to train, implement, use, and/or update the one or more AI/ML models or a portion thereof. In some embodiments, the AI/ML models represent a composite resource allocation machine learning model comprising the one or more AI/ML models For example, each of the one or more AI/ML model may comprise a component of the composite resource allocation machine learning model.

The predictive computing entity 110 may comprise a storage subsystem that may be configured to store input data, training data, and/or the like that may be used by the predictive computing entity 110 to perform predictive data analysis, image analysis, resource allocation optimization, and/or training operations of the present disclosure. In addition, the storage subsystems may be configured to store model definition data used by the predictive computing entity 110 to perform various predictive data analysis and/or training operations.

The storage subsystem may include one or more storage units, such as multiple distributed storage units that are connected through a computer network. Each storage unit in the respective computing entities may store at least one of one or more data assets and/or one or more data about the computed properties of one or more data assets. Moreover, each storage unit in the storage systems may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In some embodiments, the predictive computing entity 110 may be communicatively coupled to or more external computing entities 150 (e.g., using one or more wired and/or wireless communication techniques). In some embodiments, the external computing entities 150 may be specially configured to perform one or more steps/operations of one or more techniques described herein. In some examples, the external computing entities may be configured to train, implement, use, and/or update AI/ML models in accordance with one or more techniques of the present disclosure. The one or more external computing entities 150 may include storage subsystems, such as storage subsystem described above with respect to the predictive computing entity 110.

In some embodiments, the predictive computing entity 110 is configured to perform data intake of one or more types of data, such as resource data associated with one or more items, item feature data, and/or the like.

In some embodiments, the predictive computing entity 110 is configured to generate and/or transmit command(s) that control, adjust, or otherwise impact operation of one or more aspect of the external system 155, facilities, processes, and/or the like For example, the predictive computing entity 110 may be configured to perform resource allocation optimization in response to a resource allocation optimization request from the external system 155, such as via, a client computing entity associated with the external system 155. In some embodiments, performing resource allocation optimization includes generating optimization data.

In some embodiments, performing resource allocation optimization includes initiating the performance of one or more optimized resource allocation actions based on the optimization data. Alternatively or additionally, in some embodiments, the predictive computing entity 110 is configured to perform data reporting, provide data, and/or other data output process(es) associated with monitoring, analyzing, and/or controlling operations of one or more aspects of the external system 155.

The client computing entities 160 may be associated with users of the resource allocation optimization system 140. In various embodiments, the resource allocation optimization system 140 may generate and/or transmit a message, alert, or indication to a user via a client computing entity 160 associated with the user. Alternatively or additionally, a client computing entity 160 may be utilized by a user to remotely access the resource allocation optimization system 140. This may be by, for example, an application operating on the client computing entity 160. Such application for example, may be under the control of the resource allocation optimization system 140.

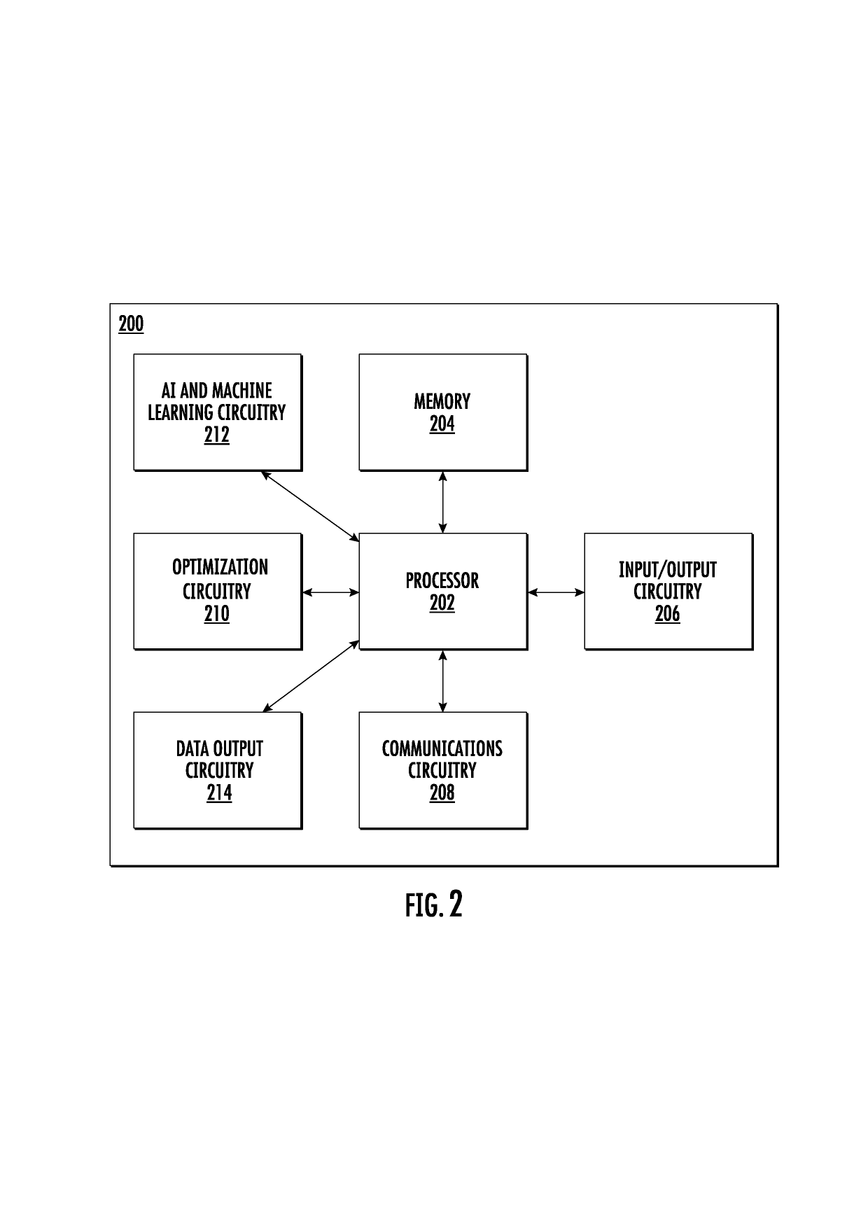

FIG. 2 illustrates a block diagram of an example apparatus that may be specially configured in accordance with at least one example embodiment of the present disclosure. Specifically, FIG. 2 depicts an example resource allocation optimization apparatus 200 (“apparatus 200”) specially configured in accordance with at least some example embodiments of the present disclosure. In some embodiments, the system 140 and/or a portion thereof is embodied by one or more system(s), such as the apparatus 200 as depicted and described in FIG. 2. The apparatus 200 includes processor 202, memory 204, input/output circuitry 206, communications circuitry 208, resource allocation optimization circuitry 210, AI and machine learning circuitry 212, and/or data output circuitry 214. In some embodiments, the apparatus 200 is configured, using one or more of the sets of circuitry embodied by processor 202, memory 204, input/output circuitry 206, communications circuitry 208, resource allocation optimization circuitry 210, AI and machine learning circuitry 212, and/or data output circuitry 214 to execute and perform the operations described herein.

In general, the terms computing entity (or “entity” in reference other than to a user), device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably. In this regard, the apparatus 200 embodies a particular, specially configured computing entity transformed to enable the specific operations described herein and provide the specific advantages associated therewith, as described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), network interface(s), storage medium(s), and/or the like, to perform their associated functions, such that duplicate hardware is not required for each set of circuitry. In some examples, “circuitry” as used herein with respect to components of the apparatuses described herein include particular hardware, software, or combination of hardware and software configured to perform the functions associated with the particular circuitry as described herein.

Particularly, the term “circuitry” should be understood broadly to include hardware only, software only, or a combination of hardware and software. In some embodiments, “circuitry” includes processing circuitry, storage media, network interfaces, input/output devices, and/or the like. Alternatively or additionally, in some embodiments, other elements of the apparatus 200 provide or supplement the functionality of another particular set of circuitry. For example, the processor 202 in some embodiments provides processing functionality to any of the sets of circuitry, the memory 204 provides storage functionality to any of the sets of circuitry, the communications circuitry 208 provides network interface functionality to any of the sets of circuitry, and/or the like.

In some embodiments, the processor 202 (and/or co-processor or any other processing circuitry assisting or otherwise associated with the processor) is/are in communication with the memory 204 via a bus for passing information among components of the apparatus 200. In some embodiments, for example, the memory 204 is non-transitory and may include, for example, one or more volatile and/or non-volatile memories. In other words, for example, the memory 204 in some embodiments includes or embodies an electronic storage device (e.g., a computer readable storage medium). In some embodiments, the memory 204 is configured to store information, data, content, applications, instructions, or the like, for enabling the apparatus 200 to carry out various functions in accordance with example embodiments of the present disclosure.

The processor 202 may be embodied in a number of different ways. For example, in some example embodiments, the processor 202 includes one or more processing devices configured to perform independently. Additionally or alternatively, in some embodiments, the processor 202 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the apparatus 200, and/or one or more remote or “cloud” processor(s) external to the apparatus 200.

In an example embodiment, the processor 202 is configured to execute instructions stored in the memory 204 or otherwise accessible to the processor. Alternatively or additionally, the processor 202 in some embodiments is configured to execute hard-coded functionality. As such, whether configured by hardware or software methods, or by a combination thereof, the processor 202 represents an entity (e.g., physically embodied in circuitry) capable of performing operations according to an embodiment of the present disclosure while configured accordingly. Alternatively or additionally, as another example in some example embodiments, when the processor 202 is embodied as an executor of software instructions, the instructions specifically configure the processor 202 to perform the algorithms embodied in the specific operations described herein when such instructions are executed. As one particular example embodiment, the processor 202 is configured to perform various operations associated with performing resource allocation optimization.

In some embodiments, the apparatus 200 includes input/output circuitry 206 that provides output to the user and, in some embodiments, to receive an indication of a user input. In some embodiments, the input/output circuitry 206 is in communication with the processor 202 to provide such functionality. The input/output circuitry 206 may comprise one or more user interface(s) and in some embodiments includes a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor may be configured to control one or more functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a client device and/or other display associated with a user.

In some embodiments, the apparatus 200 includes communications circuitry 208. The communications circuitry 208 includes any means such as a device or circuitry embodied in either hardware or a combination of hardware and software that is configured to receive and/or transmit data from/to a network and/or any other device, circuitry, or module in communication with the apparatus 200. In this regard, in some embodiments the communications circuitry 208 includes, for example, a network interface for enabling communications with a wired or wireless communications network. Additionally or alternatively in some embodiments, the communications circuitry 208 includes one or more network interface card(s), antenna(s), bus(es), switch(es), router(s), modem(s), and supporting hardware, firmware, and/or software, or any other device suitable for enabling communications via one or more communications network(s). Additionally or alternatively, the communications circuitry 208 includes circuitry for interacting with the antenna(s) and/or other hardware or software to cause transmission of signals via the antenna(s) or to handle receipt of signals received via the antenna(s). In some embodiments, the communications circuitry 208 enables transmission to and/or receipt of data from user device, one or more asset(s) or accompanying sensor(s) , and/or other external computing device in communication with the apparatus 200.

In some embodiments, the apparatus 200 includes a resource allocation optimization circuitry 210. The resource allocation optimization circuitry 210 includes hardware, software, firmware, and/or a combination thereof, that supports resource allocation optimization according to one or more techniques of the present disclosure. For example, in some embodiments, the resource allocation optimization circuitry 210 includes hardware, software, firmware, and/or a combination thereof, configured to, with the processing circuitry 202, input/output circuitry 206 and/or communications circuitry 208, perform one or more functions associated with the predictive computing entity 110 described above with respect to FIG. 1. In some embodiments, the resource allocation optimization circuitry 210 includes a separate processor, specially configured field programmable gate array (FPGA), or a specially programmed application specific integrated circuit (ASIC).

In some embodiments, the apparatus 200 includes a resource allocation optimization circuitry 210. The resource allocation optimization circuitry 210 includes hardware, software, firmware, and/or a combination thereof, that supports intelligent resource allocation optimization. For example, in some embodiments, the resource allocation optimization circuitry 210 includes hardware, software, firmware, and/or a combination thereof, configured to, with the processing circuitry 202, input/output circuitry 206 and/or communications circuitry 208, perform one or more functions associated with the predictive computing entity 110. In some embodiments, the resource allocation optimization circuitry 210 includes a separate processor, specially configured field programmable gate array (FPGA), or a specially programmed application specific integrated circuit (ASIC).

In some embodiments, the apparatus 200 may include AI and machine learning circuitry 212, data intake circuitry, and/or data output circuitry 214. In some embodiments, the data intake circuitry may include hardware, software, firmware, and/or a combination thereof, designed and/or configured to capture, receive, request, and/or otherwise gather data associated with operations of one or more plant(s). In some embodiments, the data intake circuitry includes hardware, software, firmware, and/or a combination thereof, that communicates with one or more sensor(s). unit(s), and/or the like within a particular plant to receive particular data associated with such operations of the plant. The data intake circuitry may support such operations for any number of individual plants. Additionally or alternatively, in some embodiments, the data intake circuitry includes hardware, software, firmware, and/or a combination thereof, that retrieves particular data associated with one mor more plant(s) from one or more data repository/repositories accessible to the apparatus 200.

In some embodiments, the AI and machine learning circuitry 212 may include hardware, software, firmware, and/or a combination thereof designed and/or configured to request, receive, process, generate, and transmit data, data structures, control signals, and electronic information for training and executing a trained AI and machine learning model configured to facilitating the operations and/or functionalities described herein. For example, in some embodiments the AI and machine learning circuitry 212 includes hardware, software, firmware, and/or a combination thereof, that identifies training data and/or utilizes such training data for training a particular machine learning model, AI, and/or other model to generate particular output data based at least in part on learnings from the training data. Additionally or alternatively, in some embodiments, the AI and machine learning circuitry 212 includes hardware, software, firmware, and/or a combination thereof, that embodies or retrieves a trained machine learning model, AI and/or other specially configured model utilized to process inputted data. Additionally or alternatively, in some embodiments, the AI and machine learning circuitry 212 includes hardware, software, firmware, and/or a combination thereof that processes received data utilizing one or more algorithm(s), function(s), subroutine(s), and/or the like, in one or more pre-processing and/or subsequent operations that need not utilize a machine learning or AI model.

In some embodiments, the data output circuitry 214 may include hardware, software, firmware, and/or a combination thereof, that configures and/or generates an output based at least in part on data processed by the apparatus 200. In some embodiments, the data output circuitry 214 includes hardware, software, firmware, and/or a combination thereof, that generates a particular report based at least in part on the processed data, for example where the report is generated based at least in part on a particular reporting protocol. Additionally or alternatively, in some embodiments, the data output circuitry 214 includes hardware, software, firmware, and/or a combination thereof, that configures a particular output data object, output data file, and/or user interface for storing, transmitting, and/or displaying. For example, in some embodiments, the data output circuitry 214 generates and/or specially configures a particular data output for transmission to another system sub-system for further processing. Additionally or alternatively, in some embodiments, the data output circuitry 214 includes hardware, software, firmware, and/or a combination thereof, that causes rendering of a specially configured user interface based at least in part on data received by and/or processing by the apparatus 200.

In some embodiments, two or more of the sets of circuitries 202-214 are combinable. Alternatively or additionally or in some embodiments, one or more of the sets of circuitries embodying processor 202, memory 204, input/output circuitry 206, communications circuitry 208, and/or other circuitries. perform some or all of the functionality described as associated with another component. For example, in some embodiments, two or more of the sets of circuitry embodied by processor 202, memory 204, input/output circuitry 206, communications circuitry 208, and/or other circuitries, are combined into a single module embodied in hardware, software, firmware, and/or a combination thereof.

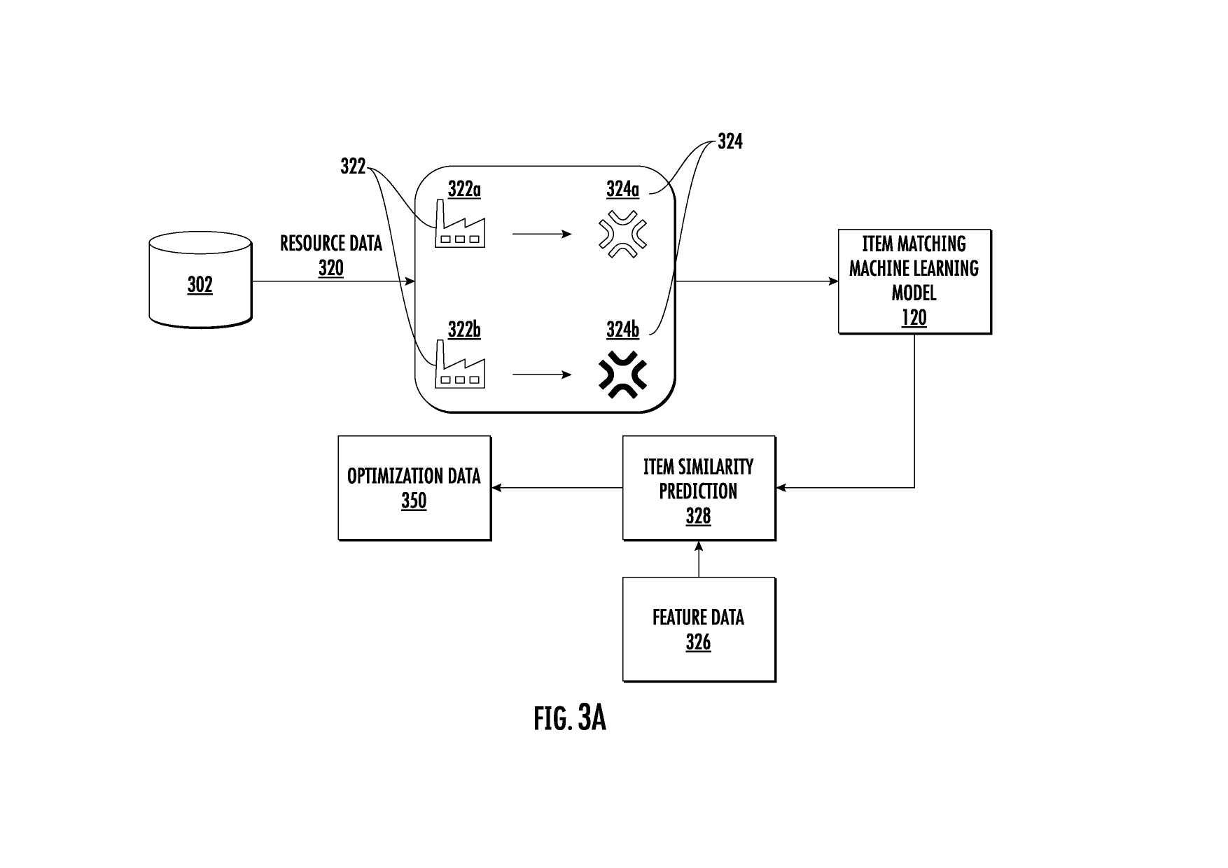

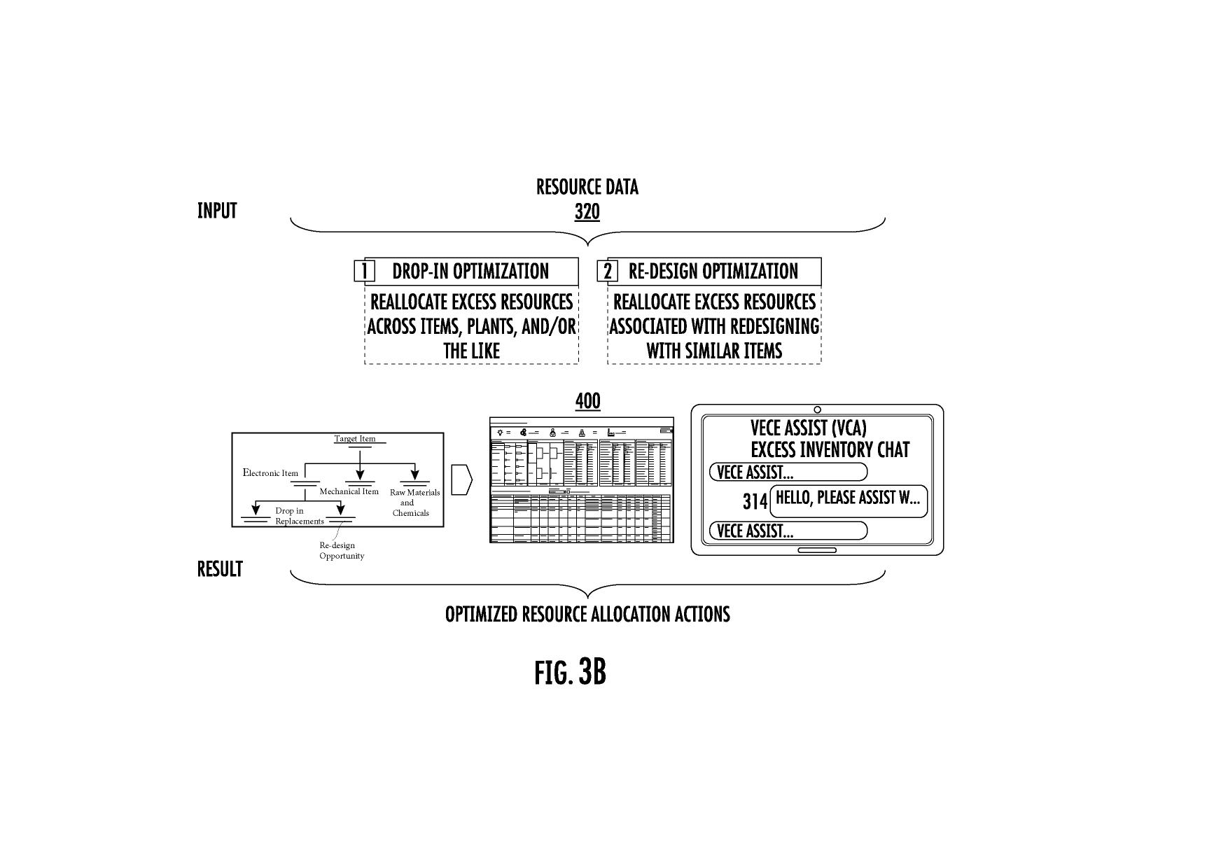

With reference to FIG. 3a and FIG. 3b. in some embodiments, an item such as item 324 (e.g., 324a, 324b) includes an electrical item, a mechanical item, an electromechanical item, a resin item, and/or the like. For example, an item may include a printed circuit board (PCB), a printed circuit board assembly (PCBA), a sensor, a bar code scanner, and/or the like. In some embodiments, an item includes one or more components that form a portion of the item. For example, a component of an item may include a portion of a printed circuit board (PCB) (e.g., an individual layer of a printed circuit board), a portion of a printed circuit board assembly (PCBA) (e.g., an individual electrical component of a printed circuit board assembly), a portion of a sensor (e.g., a controller of a sensor), a portion of a bar code scanner (e.g., an imaging component of a bar code scanner), and/or the like. In this regard, an item may represent a resource used in one or more items and/or used in the production of one or more items. A resource, for example, may describe an item configured to support performance of one or more functionalities associated with another item of which the item is a component. Alternatively or additionally, in some embodiments, a resource describes an item that represents raw materials, chemicals, and/or the like used in the production of an item.

In some embodiments, the predictive computing entity 110 is configured to identify resource data 320 associated with a plurality of items 324. For example, the resource data 320 may include resource data for each item of at least two items. In some embodiments, the plurality of items may be associated with one or more facilities 322 (e.g., 322a, 322b), such as for example one more plants. In some embodiments the one or more facilities may be associated with an external system, such as external system 155. In some embodiments, the one or more facilities may comprise a plurality of facilities distributed across a geographical area. For example, at least two facilities may be located in different geographical regions, such as for example different towns, different cities, different states, and/or the like.

In some embodiments, resource data for an item includes one or more items of data representative and/or indicative of one or more conditions of the item. In this regard, resource data may be referred to herein as item condition data comprising one or more items of data that describes one or more conditions of an item. In some embodiments, resource data for an item includes item utilization condition data representative and/or indicative of a state (e.g., item utilization status) of an item. An example of item utilization condition data is inventory status of an item such as, for example, excess inventory, low inventory, and/or the like. In some embodiments item utilization condition data for an item may be with respect to a particular facility and/or group of facilities. In some embodiments, the group of facilities may represent a single site. For example, in some embodiments, item utilization condition data may describe utilization status of an item at a particular facility or group of facilities. Alternatively or additionally, in some embodiments, resource usage data for an item includes usage rate data representative and/or indicative of a the rate of use of an item with respect to a particular facility or group of facilities.

In some embodiments, the predictive computing entity 110 is configured to identify the resource data 320 in response to receiving a resource allocation optimization request from a client computing entity 160 and/or an external system such as external system 155.

In some embodiments, resource allocation optimization request is signal, data, message (e.g., an inter-service message, intra-service message, network message, etc.), and/or computer readable instructions descriptive of a request to provide optimization data with respect to a particular item and/or a plurality of items identified in the resource allocation optimization request. In some embodiments, a resource allocation optimization request such as, for example, resource allocation optimization request 314 may include data that describes one or more item (e.g., resistors, capacitors, integrated circuit, or the like) for which resource allocation optimization is requested.

In some embodiments, identifying resource data 320 comprises receiving the resource data 320 via the external system 155. For example, the external system may store and/or maintain various data associated with the external system 155. For example, the external system 155 may include a data storage system 302, such as an enterprise system that stores and/or maintains enterprise data. In some embodiments, enterprise data comprise various data associated with an enterprise, a group, an organization, one or more facilities, and/or the like.

In some embodiments, receiving resource data via such external system includes the predictive computing entity 110 establishing a data intake connection with the external system (e.g., via one or more computing entities 160 associated with the external system) In some embodiments, the predictive computing entity 110 is configured to establish data intake connection via one or more application program interfaces (APIs), and/or via any suitable data intake connection methods. In certain embodiments, the predictive computing entity 110 is configured to establish data intake connection via web service-based connector(s). In some embodiments, data intake connection describes a communication link between computing entities and/or systems that provides for data transmission and/or data access between the computing entities and/or systems such as, for example, between the predictive computing entity 110 and a client computing entities 160, between the predictive computing entity 110 and the external system 155, or the like.

In some embodiments, receiving resource data via such external system includes the predictive computing entity 110 accessing data (e.g., enterprise data) maintained via the external system (e.g., via an enterprise system associated with the external system, and/or other data storage systems) and extracting resource data 320 from the data maintained via the external system. In some embodiments, the predictive computing entity 110 may access such data maintained via the enterprise system in response to establishing a data intake connection as describe above.

In some embodiments, the predictive computing entity 110 is configured to extract resource data 320 from the various data maintained via the external system using an extraction machine learning model. The predictive computing entity 110, for example, may be configured to apply the extraction machine learning model to the data maintained via the external system.

In some embodiments, the extraction machine learning model is a data entity that describes parameters, hyper-parameters, and/or defined operations of a rules-based algorithm, machine learning model (e.g., model including at least one or more rule-based layers, one or more layers that depend on trained parameters, coefficients, and/or the like), and/or artificial intelligence model, and/or the like. An extraction machine learning model may include any type of model configured, trained, and/or the like to extract resource data from a data storage system such as a database, an enterprise system, and/or the like. In this regard, an extraction machine learning model may be configured to utilize one or more of any types of machine learning, rules-based, and/or artificial intelligence techniques including one or more of computer vision techniques, supervised learning (e.g., using user feedback), unsupervised learning, semi-supervised learning, reinforcement learning, computer vision techniques, sequence modeling techniques, language processing techniques, neural network techniques, and/or generative artificial intelligence techniques. For example, the extraction machine learning model may be configured to employ one or more techniques configured to traverse and analyze data maintained via the external system and output resource data 320 comprising resource data for one or more items. In some embodiments, the extraction machine learning model is a component of a composite resource allocation machine learning model, as described above.

In embodiments, where the predictive computing entity 110 receives resource allocation optimization request that specifies one or more items, the extraction machine learning model, may be configured to extract resource data 320 that includes at least resource data for the one or more items specified, such as item utilization condition data for the one or more items.

In some embodiments, receiving data stored via an external system to generate resource data 320 includes performing, by the predictive computing entity 110 and/or by the extraction machine learning model, data transformation operation(s) configured to transform a portion of the data stored via an external system. For example, the predictive computing entity and/or extraction machine learning model may be configured to generate a representation of item utilization such as item utilization trend data that reflects utilization status of an item over a specified period of time. As another example, the predictive computing entity 110 and/or extraction machine learning model may be configured to perform transforming operation(s) that includes applying one or more transformation techniques to data stored via the external system to calculate item utilization condition data and/or other components of resource data 320.

In some embodiments, the predictive computing entity 110 is configured to generate item similarity prediction data 328 (referred to interchangeably herein as similarity prediction data 328) based on the resource data 320. In some embodiments, item similarity prediction data 328 comprises one or more items of data that describes similarities between at least two items of a plurality of items 324 whose resource data is included in the resource data 320. In particular, in some embodiments, similarity prediction data 328 comprises at least one predicted similar items subset from the plurality of items 324 whose resource data is included in the resource data 320. In some embodiments, a similar items subset comprises at least one target item from the plurality of items 324 and one or more similar items from the plurality of items 324.

In some embodiments, a target item is an item associated with a first item utilization status. In some embodiments, a first item utilization status may correspond to excess inventory status for the item and may be indicative of abnormal utilization. For example, the first item utilization status corresponding to excess inventory status may be indicative of unexpected and/or unplanned reduced utilization of an item.

In some embodiments, a second item utilization status may correspond to low inventory status for the item and may be indicative of abnormal utilization. For example, the second item utilization status corresponding to low inventory status may be indicative of unexpected and/or unplanned increased utilization of an item, shortage of an item, obsolescence of the item, and/or the like.

In some embodiments, a similar item is an item determined by the predictive computing entity 110 to be substantially similar to a target item based on one or more item features. In some embodiments, the one or more item features comprises identifying data such as item part number (e.g., manufacturer part number for the item). Alternatively or additionally, in some embodiments, the one or more item features comprises technical features/technical characteristics (e.g., specification for or more operating characteristics and/or physical characteristics of an item). Alternatively or additionally, in some embodiments, the one or more item features comprises demand data associated with the plurality of items or the predicted similar items subset. Alternatively or additionally, in some embodiments, the one or more item features comprises obsolescence data associated with the plurality of items or the predicted similar item subset. In some embodiments, demand data comprise one or more items of data representative and/or indicative of a demand for an item (e.g., a quantity of an item required or otherwise being requested for use as a component (e.g., in a parent item), requested by third-parties, requested by end-users, and/or the like). In some embodiments, obsolescence data comprise one or more items of data representative and or indicative of an end of life of at least one item of the plurality of items. Alternatively and/or additionally, obsolescence data may comprise one or more items of data representative and/or indicative of unavailability of an item, such as for example an item that is longer in use and/or no longer being manufactured/produced.

In some embodiments, the predictive computing entity 110 leverages an item matching machine learning model 120 to generate item similarity prediction data 328. In some embodiments, the predictive computing entity 110 includes the item matching machine learning model 120 or is associated with the item matching machine learning model 120. The predictive computing entity 110 may be configured to apply the resource data 320 to the item matching machine learning model 120. In some embodiments, applying the resource data 320 to the item matching machine learning model 120 comprises inputting the resource data 320 into the item matching machine learning model 120 and obtaining item similarity prediction data 328 from the item matching machine learning model 120.

In some embodiments, the item matching machine learning model 120 is a data entity that describes parameters, hyper-parameters, and/or defined operations of a rules-based algorithm and/or machine learning model (e.g., model including at least one or more rule-based layers, one or more layers that depend on trained parameters, coefficients, and/or the like), and/or artificial intelligence model, and/or the like. An item matching machine learning model 120 may include any type of model configured, trained, and/or the like to generate item similarity prediction data. In this regard, an item matching machine learning model 120 may be configured to utilize one or more of any types of machine learning, rules-based, and/or artificial intelligence techniques including one or more of computer vision techniques, supervised learning (e.g., using user feedback), unsupervised learning, semi-supervised learning, reinforcement learning, computer vision techniques, sequence modeling techniques, language processing techniques, neural network techniques, and/or generative artificial intelligence techniques. For example, the item matching machine learning model 120 may be configured to employ fuzzy similarity techniques to perform fuzzy similarity-based predictive data analysis operation on the resource data 320 to generate item similarity predictions for at least two items. In some embodiments, the item matching machine learning model 120 is a component of a composite resource allocation machine learning model, as described above.

In some embodiments, the predictive computing entity 110 is configured to identify item feature data 326 associated with the plurality of items 324. In some embodiments, identifying item features data 326 associated with the plurality of items 324 includes identifying item feature data associated with the at least one similar items subset.

In some embodiments, identifying the item feature data 326 comprises receiving the item feature data 326 (or portion thereof) via one or more external sources. For example, the predictive computing entity 110 may be configured to transmit a data retrieval request to the one or more external sources configured to cause the predictive computing entity 110 to receive the item feature data 326 (or a portion thereof) from one or more external sources. The one or more external sources, for example, may store and/or maintain feature data (or portion thereof) associated with one or more items, including item feature data 326 (or a portion thereof). In some embodiments, the one or more external sources include data storage system(s) associated with manufacturer(s) of the items included in the at least one similar items subset. In some embodiments, the one or more external sources include data storage system(s) associated with manufacturer(s) of each of the plurality of items 324.

In some embodiments, data retrieval request is signal, data, message (e.g., an inter-service message, intra-service message, network message, etc.), and/or computer readable instructions descriptive of a request to provide item feature data with respect to a particular item and/or a plurality of items.

Alternatively or additionally, in some embodiments, identifying the item feature data 326 comprises receiving the item feature data 326 (or a portion thereof) via the one or more external systems. For example, the predictive computing entity 110 may be configured to transmit a data retrieval request to the one or more external systems configured to cause the predictive computing entity 110 to receive the item feature data 326 (or a portion thereof) from the one or external systems. The one or more external systems, for example, may store and/or maintain feature data (or a portion thereof) associated with one or more items.

In some embodiments, the predictive computing entity 110 is configured to generate optimization data 350. In some embodiments, the optimization data includes one or more items of data that describes one or more items and/or features of one or more items identified as optimal similar item for, temporarily or permanently, substituting or replacing a target item at a facility associated with the target item to improve resource allocation of items associated with the external system. For example, the optimization data may comprise an optimal similar item selected from the one or more similar items in a predicted similar items subset that includes the target item.

In some embodiments, an optimal similar item is a similar item relative to a target item and that is associated with a second item utilization status. As described above, in some embodiments, a first item utilization status may correspond to excess inventory status and a second item utilization status may correspond to low inventory status for the item.

In some embodiments, the optimization data 350 includes optimal similar item for a target item that is different from the target item but deemed substantially similar. In this regard, the predictive computing entity 110 may be configured to identify opportunities for item design modification to support optimal resource allocation.

Alternatively or additionally, the optimization data 350 includes one or more items of data that describes one or more actions that may be performed to improve resource allocation of items associated with the external system.

In some embodiments, the predictive computing entity 110 leverages a resource allocation optimization machine learning model to generate the optimization data 350. In some embodiments, the predictive computing entity 110 includes the resource allocation optimization machine learning model or is associated with the resource allocation optimization machine learning model. The predictive computing entity 110 may be configured to apply the item similarity prediction data 328 and the item feature data 326 to the resource allocation optimization machine learning model. In some embodiments, applying the item similarity predictions 328 and the item feature data 326 to the resource allocation optimization machine learning model comprises inputting the item similarity prediction data 328 and the item feature data 326 into the resource allocation optimization machine learning model and obtaining the optimization data from the resource allocation optimization machine learning model.

In some embodiments, the resource allocation optimization machine learning model is a data entity that describes parameters, hyper-parameters, and/or defined operations of a rules-based algorithm and/or machine learning model (e.g., model including at least one or more rule-based layers, one or more layers that depend on trained parameters, coefficients, and/or the like), and/or artificial intelligence model, and/or the like. A resource allocation optimization machine learning model may include any type of model configured, trained, and/or the like to generate resource allocation optimization data. In this regard, a resource allocation optimization machine learning model may be configured to utilize one or more of any types of machine learning, rules-based, and/or artificial intelligence techniques including one or more of computer vision techniques, supervised learning (e.g., using user feedback), unsupervised learning, semi-supervised learning, reinforcement learning, computer vision techniques, sequence modeling techniques, language processing techniques, neural network techniques, and/or generative artificial intelligence techniques. For example, the resource allocation optimization machine learning model may be configured to employ optimization techniques to perform optimization-based predictive data analysis operation on the item similarity prediction data 328 and the item feature data 326 to generate optimization data 350. In some embodiments, the resource allocation optimization machine learning model is a component of a composite resource allocation machine learning model, as described herein.

In some embodiments, the predictive computing entity 110 is configured to initiate performance of one or more optimized resource allocation actions. In some embodiments, the predictive computing entity 110 is configured to initiate performance of one or more optimized resource allocation actions in response to generation of optimization data 350. In this regard, in some embodiments, the predictive computing entity 110 is configured to initiate performance of one or more optimized resource allocation actions using optimized data. In some embodiments, as described above, optimization data 350 includes at least one target item and one optimal similar item. In some embodiments, the optimization data may include resource data (or portion thereof) associated with the target item and optimal similar item. In this regard, in some embodiments, the predictive computing entity 110 is configured to initiate performance of one or more optimized resource allocation actions based on and/or using optimization data comprising one or more items of data describing target item and optimal similar item, and/or resource data associated with the target item and optimal similar item.

In some embodiments, initiating performance of one or more optimized resource allocation actions includes the predictive computing entity 110 being configured to generate a resource allocation optimization interface component 402 (described further below). In some embodiments, the resource allocation optimization interface component 402 includes one or more interface elements configured to display various portions of the optimization data 350 and/or related data.

In some embodiments, initiating performance of one or more optimized resource allocation actions includes causing, by the predictive computing entity 110, the resource allocation optimization interface component 402 to be rendered to a resource allocation optimization interface 400. In some embodiments, the resource allocation optimization interface 400 may be provided on the predictive computing entity 110. Additionally, or alternatively, the resource allocation optimization interface 400 may be provided on the client computing entities 160.

In some embodiments, initiating performance of one or more optimized resource allocation actions includes causing, by the predictive computing entity 110, an item design data associated with an optimal similar item or target item to be modified. In some embodiments, an item design data comprises one or more items of data that describes components of the item. Alternatively or additionally, in some embodiments, an item design data may comprise one or more items of data that describes connections between components of an item. In this regard, for example, design data for an item may be modified to replace an optimal similar item in the item design data with a target item, such as when resource allocation can be improved by re-allocating and utilizing the target item.

In some embodiments, initiating performance of one or more optimized resource allocation actions includes causing, by the predictive computing entity 110, a target item (e.g., portion of target item inventory) to be relocated from a first facility location to a second facility location. In some embodiments, the first facility location and the second facility location may be within the same facility. In some embodiments, the first facility location and the second facility location may be associated with different facilities. For example, where the target item is associated with a first item utilization status (e.g., corresponding to excess inventory) the predictive computing entity 110 may cause the target item (e.g., a portion of the target item inventory) to be relocated to a facility location associated with the optimal similar item that is associated with a second item utilization condition (e.g., corresponding to low inventory).

In some embodiments, initiating performance of one or more optimized resource allocation actions includes causing, by the predictive computing entity 110, a target item to be utilized in place of an optimal similar item.

In some embodiments, initiating performance of one or more optimized resource allocation actions includes causing, by the predictive computing entity 110, a manufacturing procedure associated with optimal similar item to be modified. In some embodiments, an item manufacturing procedure is a series of steps that are performed to generate and/or create a first item (e.g., a parent item) that includes a second item (child item). In this regard, in some embodiments, the predictive computing entity 110 is configured to cause an item manufacturing procedure associated with a target item and/or corresponding optimal similar item to be modified based on the optimization data.

In some embodiments, initiating performance of one or more optimized resource allocation actions includes the predictive computing entity 110 being configured to cause resource record associated with the plurality of items to be modified. In some embodiments, a resource record is a record that indicates items associated with one or more facilities, which may be associated with an external system such as external system 155. In this regard, for example, resource record may be modified to remove an item, temporarily or permanently, from the resource record, such as when optimization data indicates that utilization of a target item in place of optimal similar item improves resource allocation or indicates that utilization of an optimal similar item in place of the target item improves resource allocation. In some embodiments, modifying an item resource record to remove an item may include causing, by the predictive computing entity 110, of signals, transmission, and/or the like to a third-party system, such as a supplier system to cancel an order for the removed item or temporarily hold supply of the item.

In some embodiments, initiating performance of one or more optimized resource allocation actions includes generating, by the predictive computing entity 110, item comparison report. In some embodiments, item comparison report is a report that provides a comparison between two or more items. In some embodiments, the item comparison report may be in a tabular format. In some embodiments, the item comparison report may include one or more images associated with the two or more items being compared. In some embodiments, initiating performance of one or more optimized resource allocation actions may include causing the item(s) and related item comparison report to be provided on the resource allocation optimization interface component 402.

In some embodiments, initiating performance of one or more optimized resource allocation actions includes determining predicted reduction in impact value associated with a prospective item reallocation based on the optimization data. In some embodiments, optimization data may be accepted or rejected based on the predicted reduction in impact value.

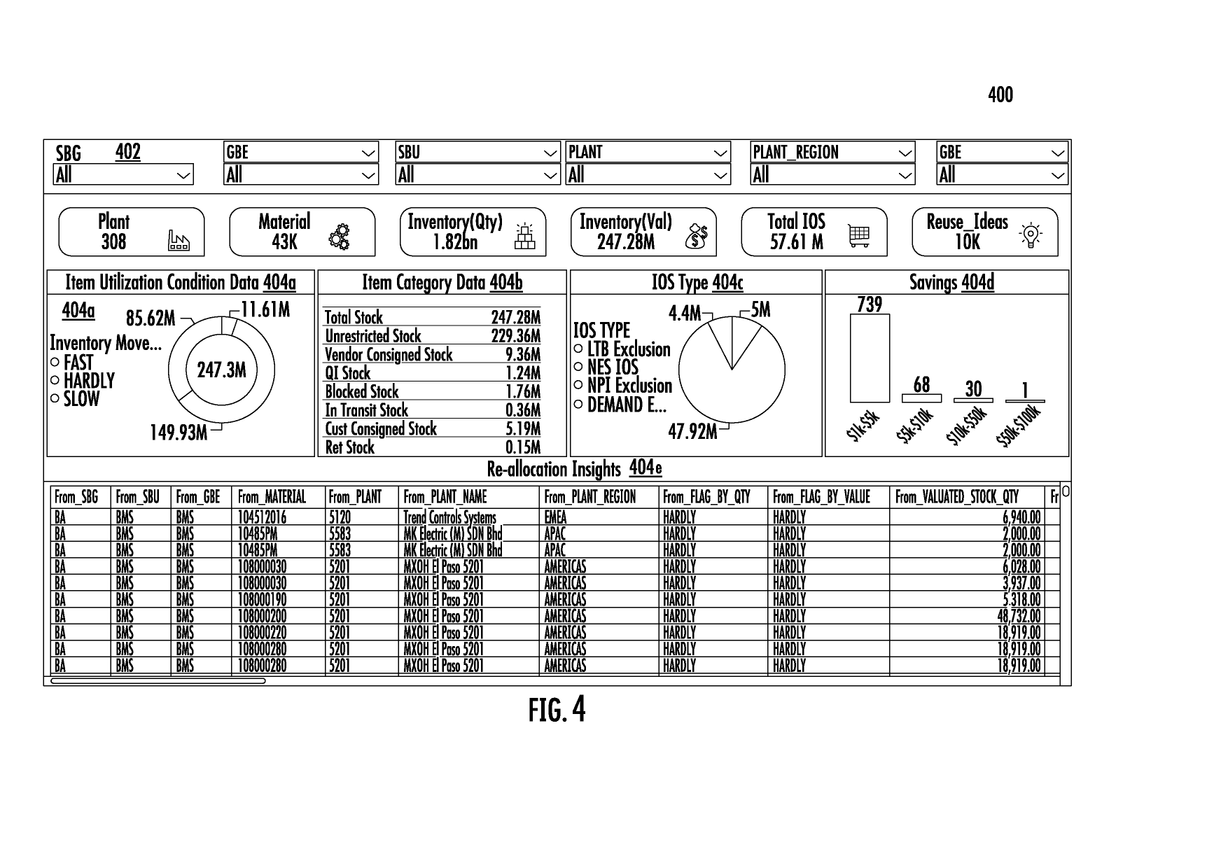

FIG. 4 illustrates an example resource allocation optimization interface 400 in accordance with at least one example embodiment of the present disclosure. The resource allocation optimization interface 400 may be, for example, an electronic interface (e.g., graphical user interface) of a client computing entity. The resource allocation optimization interface 400 may be configured for presenting or otherwise displaying a visualization of the optimization data (e.g., at least a portion of the optimization data) and/or related data. For example, the resource allocation optimization interface 400 may be configured for presenting a resource allocation optimization interface component 402 comprising a visualization of optimization data and/or related data as described herein. As described above, in some embodiments, the predictive computing entity 110 is configured to generate the resource allocation optimization interface component 402.

In the illustrated example depicted in FIG. 4, the resource allocation optimization interface 400 or otherwise resource allocation optimization interface component 402 may include one or more interface elements such as, for example, interface elements 404a-e. Each interface element may be configured for presenting one or more representations of optimization data (or portion thereof) generated as described herein. Such representations may include textual representation (e.g., text), image representations, graphical representations (e.g., pie charts, bar charts, and/or the like).

As shown in the example illustrated in FIG. 4, interface element 404a-e may be configured for presenting a visualization of various portions of optimization data or related data. For example, in the illustrated example of FIG. 4, interface element 404a may be configured to present a visualization of item utilization condition data; interface element 404b may be configured to present a visualization of item category data (e.g., one or more items of data that describes the category of an item), interface element 404c may be configured for presenting a visualization of data that describes IOS type; interface element 404e may be configured for presenting reallocation insight data (e.g., data representative and/or indicative of recommended and/or implemented resource reallocation across multiple plants. For example, interface element 404e may include data that includes a target item and the optimal similar item. It will be appreciated that the resource allocation optimization interface 400 and/or resource allocation optimization interface component 402 may comprise other interface elements, omit one or more of the example interface elements, and/or be configured other portions of the optimization data (e.g., generated as described herein) and/or related data.

### EXAMPLE PROCESSES/METHODS OF THE DISCLOSURE

Having described example systems and apparatuses, and data visualizations in accordance with the disclosure, example processes/methods of the disclosure will now be discussed. It will be appreciated that each of the flowcharts depicts an example computer-implemented process that is performable by one or more of the apparatuses, systems, devices, and/or computer program products described herein, for example utilizing one or more of the specially configured components thereof.

Although the example processes depicts a particular sequence of operations, the sequence may be altered without departing from the scope of the present disclosure. For example, some of the operations depicted may be performed in parallel or in a different sequence that does not materially affect the function of the processes.

The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

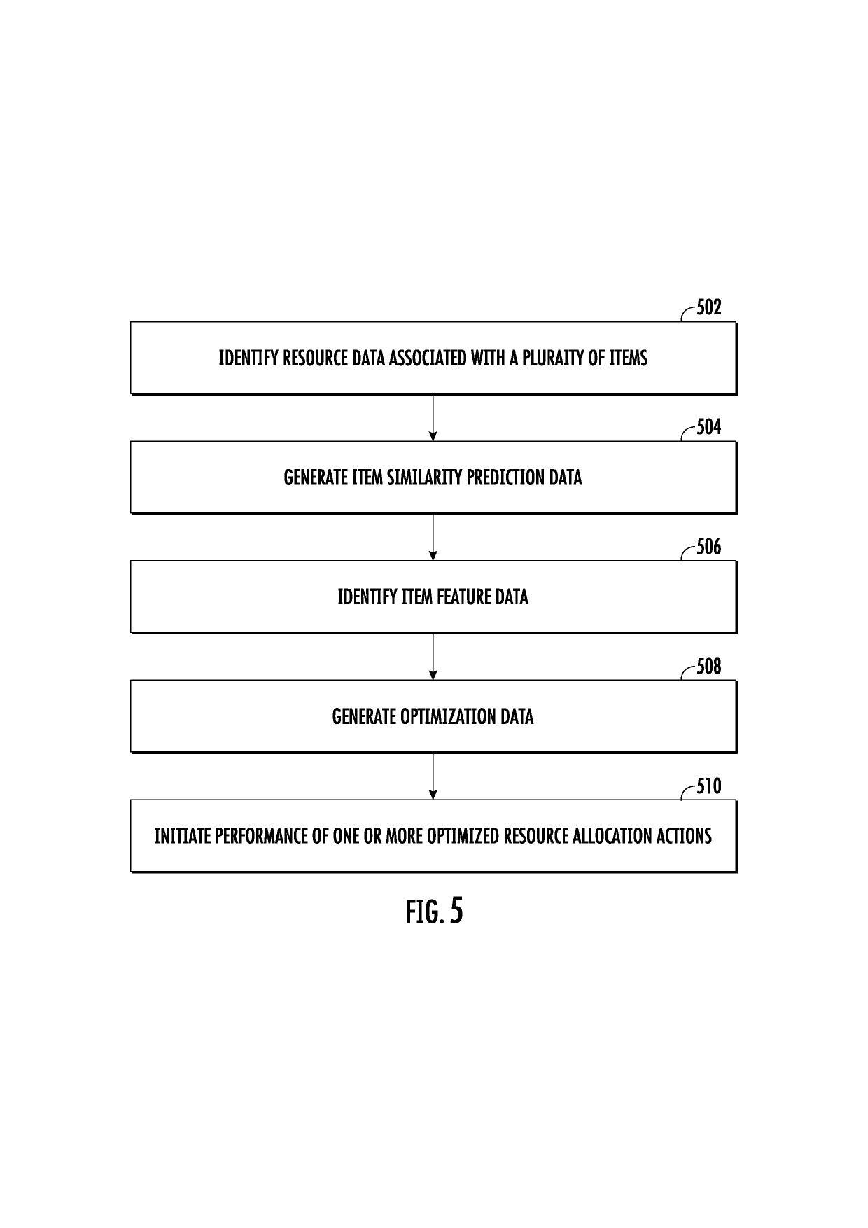

FIG. 5 illustrates a flowchart for resource allocation optimization in accordance with at least one example embodiment of the present disclosure. In some embodiments, the process/method 500 is embodied by computer program code stored on a non-transitory computer-readable storage medium of a computer program product configured for execution to perform the process as depicted and described. Alternatively or additionally, in some embodiments, the process/method 500 is performed by one or more specially configured computing devices, such as the apparatus 200 alone or in communication with one or more other component(s), device(s), system(s), and/or the like. In this regard, in some such embodiments, the apparatus 200 is specially configured by computer-coded instructions (e.g., computer program instructions) stored thereon, for example in the memory 204 and/or another component depicted and/or described herein and/or otherwise accessible to the apparatus 200, for performing the operations as depicted and described. In some embodiments, the apparatus 200 is in communication with one or more external apparatus(es), system(s), device(s), and/or the like, to perform one or more of the operations as depicted and described. For example, the apparatus 200 in some embodiments is in communication with separate component(s) of a network, external network(s), and/or the like, to perform one or more of the operation(s) as depicted and described. For purposes of simplifying the description, the process/method 500 is described as performed by and from the perspective of the apparatus 200.

Although the example process/method 500 depicts a particular sequence of operations, the sequence may be altered without departing from the scope of the present disclosure. For example, some of the operations depicted may be performed in parallel or in a different sequence that does not materially affect the function of the process/method 500. In other examples, different components of an example device or system that implements the process/method 500 may perform functions at substantially the same time or in a specific sequence.

According to some examples, the process/method 500 includes at operation 502, identifying resource data associated with a plurality of items. For example, the apparatus 200 may identify resource data associated with at least two items. As described above, in some embodiments, an item includes an electrical item, a mechanical item, an electromechanical item, a resin item, and/or the like. For example, an item may include a printed circuit board (PCB), a printed circuit board assembly (PCBA), a sensor, a bar code scanner, and/or the like In some embodiments, an item includes one or more components that form a portion of the item. For example, a component of an item may include a portion of a printed circuit board (PCB) (e.g., an individual layer of a printed circuit board), a portion of a printed circuit board assembly (PCBA) (e.g., an individual electrical component of a printed circuit board assembly), a portion of a sensor (e.g., a controller of a sensor), a portion of a bar code scanner (e.g., an imaging component of a bar code scanner), and/or the like. In this regard, an item may represent a resource configured to support performance of one or more functionalities associated with another item of which the item is a component. Further, as described above, the plurality of items may be associated with one or more facilities.

In some embodiments, the apparatus 200 is configured to identify the resource data in response to receiving a resource allocation optimization request from a client computing entity such as a client computing entity associated with an external system requesting resource allocation optimization. In some embodiments, the apparatus identifies the resource data by receiving the resource data via the external system. In some embodiments, receiving resource data via an external system includes the apparatus 200 establishing a data intake connection with the external system (e.g., via one or more computing entities associated with the external system) to access, retrieve, receive, or otherwise obtain resource data from data maintained via the external system. In some embodiments, the apparatus 200 is configured to establish the data intake connection via web service-based connector(s), API(s), and/or the like.

Alternatively or additionally, in some embodiments, the apparatus 200 is configured to receive the resource data via an external system by extracting the resource data from the various data maintained via the external system using an extraction machine learning model. The apparatus 200, for example, may apply the extraction machine learning model to the data maintained via the external system in response to establishing data intake connection with the external system.

In some embodiments, the extraction machine learning model is a data entity that describes parameters, hyper-parameters, and/or defined operations of a rules-based algorithm, machine learning model (e.g., model including at least one or more rule-based layers, one or more layers that depend on trained parameters, coefficients, and/or the like), and/or artificial intelligence model, and/or the like. An extraction machine learning model may include any type of model configured, trained, and/or the like to extract resource data from a data storage system such as a database, an enterprise system, and/or the like. In this regard, an extraction machine learning model may be configured to utilize one or more of any types of machine learning, rules-based, and/or artificial intelligence techniques including one or more of computer vision techniques, supervised learning (e.g., using user feedback), unsupervised learning, semi-supervised learning, reinforcement learning, computer vision techniques, sequence modeling techniques, language processing techniques, neural network techniques, and/or generative artificial intelligence techniques. For example, the extraction machine learning model may be configured to employ one or more techniques configured to traverse and analyze data maintained via the external system (e.g., stored and/or maintained by a storage system associated with the external system) and output resource data associated with item(s) associated with the external system, such as resource data.

According to some examples, the process/method 500 includes at operation 504, generating item similarity prediction data for the plurality of items. In some embodiments, similarity prediction data comprises at least one predicted similar items subset from the plurality of items identified at operation 502. In some embodiments, the predicted similar items subset comprises at least one target item from the plurality of items and one or more similar items from the plurality of items. In some embodiments, an item matching machine learning model is leveraged to generate the similarity prediction data. For example, the apparatus 200, using an item matching machine learning model may generate similarity prediction data. In some embodiments, the apparatus 200 includes an item matching machine learning model or is associated with an item matching machine learning model.

The apparatus 200 may be configured to apply the resource data to the item matching machine learning model. In some embodiments, applying the resource data to the item matching machine learning model includes, the apparatus 200, inputting the resource data into the item matching machine learning model 120 and obtaining similarity prediction data from the item matching machine learning model.

In some embodiments, the item matching machine learning model is a data entity that describes parameters, hyper-parameters, and/or defined operations of a rules-based algorithm and/or machine learning model (e.g., model including at least one or more rule-based layers, one or more layers that depend on trained parameters, coefficients, and/or the like), and/or artificial intelligence model, and/or the like. An item matching machine learning model may include any type of model configured, trained, and/or the like to generate item similarity prediction data. In this regard, an item matching machine learning model may be configured to utilize one or more of any types of machine learning, rules-based, and/or artificial intelligence techniques including one or more of computer vision techniques, supervised learning (e.g., using user feedback), unsupervised learning, semi-supervised learning, reinforcement learning, computer vision techniques, sequence modeling techniques, language processing techniques, neural network techniques, and/or generative artificial intelligence techniques. For example, the item matching machine learning model may be configured to employ fuzzy similarity techniques to perform fuzzy similarity-based predictive data analysis operation on the resource data 320 to generate item similarity predictions (e.g., item similarity prediction data) for at least two items.

According to some examples, the process/method 500 includes at operation 506, identifying item feature data associated with the plurality of items. For example, the apparatus 200 may identify item features data associated with the at least one predicted similar items subset generated at operation 504. In some embodiments, identifying the item feature data includes receiving the item feature data via one or more external sources. For example, the apparatus 200 may be configured to transmit a data retrieval request to the one or more external sources configured to cause the apparatus 200 to receive the item feature data (or a portion thereof) from one or more external sources. The one or more external sources, for example, may store and/or maintain feature data associated with one or more items, including item feature data (or a portion thereof). In some embodiments, the one or more external sources include data storage system(s) associated with manufacturer(s) of the items included in the at least one similar items subset. In some embodiments, the one or more external sources include a data storage system(s) associated with manufacturer(s) of each of the plurality of items.

Alternatively or additionally, in some embodiments, identifying the item feature data 326 comprises receiving the item feature data (or a portion thereof) via the one or more external systems. For example, the apparatus 200 may be configured to transmit a data retrieval request to the one or more external systems configured to cause the apparatus 200 to receive the item feature data (or a portion thereof) from the one or external systems. The one or more external systems, for example, may store and/or maintain feature data associated with one or more items.

According to some examples, the process/method 500 includes at operation 508 generating optimization data. For example, the apparatus 200 may generate optimization data for the external system based on at least the item feature data and the at least one predicted item similarity subset. In some embodiments, the optimization data includes one or more items of data that describes one or more items and/or features of one or more items identified as optimal similar item for, temporarily or permanently, substituting or replacing a target item at a facility associated with the target item to improve resource allocation of items associated with the external system. Alternatively or additionally, the optimization data includes one or more items of data that describes one or more actions that may be performed to improve resource allocation of items associated with the external system.

In some embodiments, the apparatus 200 leverages a resource allocation optimization machine learning model to generate the optimization data. In some embodiments, the apparatus 200 includes the resource allocation optimization machine learning model or is otherwise associated with the resource allocation optimization machine learning model 120. The apparatus 200 may be configured to apply the item similarity prediction and the item feature data to the resource allocation optimization machine learning model. In some embodiments, applying the item similarity predictions and the item feature data to the resource allocation optimization machine learning model comprises inputting, by the apparatus 200, the item similarity prediction and the item feature data into the resource allocation optimization machine learning model and obtaining the optimization data from the resource allocation optimization machine learning model.

In some embodiments, the resource allocation optimization machine learning model is a data entity that describes parameters, hyper-parameters, and/or defined operations of a rules-based algorithm and/or machine learning model (e.g., model including at least one or more rule-based layers, one or more layers that depend on trained parameters, coefficients, and/or the like), and/or artificial intelligence model, and/or the like. A resource allocation optimization machine learning model may include any type of model configured, trained, and/or the like to generate resource allocation optimization data. In this regard, a resource allocation optimization machine learning model may be configured to utilize one or more of any types of machine learning, rules-based, and/or artificial intelligence techniques including one or more of computer vision techniques, supervised learning (e.g., using user feedback), unsupervised learning, semi-supervised learning, reinforcement learning, computer vision techniques, sequence modeling techniques, language processing techniques, neural network techniques, and/or generative artificial intelligence techniques. For example, the resource allocation optimization machine learning model may be configured to employ optimization techniques to perform optimization-based predictive data analysis operation on the item similarity prediction and the item feature data 326 to generate optimization data.

According to some examples, the process/method 500 includes at operation 510 initiating the performance of one or more optimized resource allocation actions. For example, the apparatus 200 may initiate performance of one or more optimized resource allocation actions based on the optimized data. In some embodiments, the apparatus 200 is configured to initiate performance of one or more optimized resource allocation actions in response to generation of optimization data (e.g., generated at operation 508). In this regard, in some embodiments, the apparatus 200 is configured to initiate performance of one or more optimized resource allocation actions using optimized data.

In some embodiments, as described above, optimization data includes at least a target item and optimal similar item. In some embodiments, the optimization data includes resource data (or portion thereof) associated with at least the target item and optimal similar item. In this regard, in some embodiments, the apparatus 200 is configured to initiate performance of one or more optimized resource allocation actions based on and/or using optimization data comprising one or more items of data describing a target item, optimal similar item, and/or resource data associated with the target item and optimal similar item.

In some embodiments, initiating performance of one or more optimized resource allocation actions includes generating, by the apparatus 200, a resource allocation optimization interface component such as resource allocation optimization interface component 402. In some embodiments, the resource allocation optimization interface component includes one or more interface elements configured to display various portions of the optimization data.

In some embodiments, initiating performance of one or more optimized resource allocation actions includes causing, by the apparatus 200, the resource allocation optimization interface component to be rendered to a resource allocation optimization interface. In some embodiments, the resource allocation optimization interface may be provided on the apparatus 200. Additionally, or alternatively, the resource allocation optimization interface may be provided on one or more client computing entities.

In some embodiments, initiating performance of one or more optimized resource allocation actions includes causing, by the apparatus 200, an item design data associated with a target item or optimal similar item to be modified. In some embodiments, an item design data comprises one or more items of data that describes components of the item. Alternatively or additionally, in some embodiments, an item design data may comprise one or more items of data that describes connections between components of an item. In this regard, for example, design data for an item may be modified to replace an item (e.g., optimal similar item) in the item design data with another item (e.g., target item), such as when resource allocation can be improved by re-allocating and utilizing the target item.

In some embodiments, initiating performance of one or more optimized resource allocation actions includes causing, by the apparatus 200, a target item (e.g., portion of inventory of the target item) to be relocated from a first location to a second location. In some embodiments, the first location and the second location may be within the same facility. In some embodiments, the first location and the second location may be associated with different facilities. In some embodiments, initiating performance of one or more optimized resource allocation actions includes causing, by the apparatus 200, a target item to be utilized in place of an optimal similar item or an optimal similar item to be utilized in place of a target item.

In some embodiments, initiating performance of one or more optimized resource allocation actions includes causing, by the apparatus 200, a manufacturing procedure associated with a target item or optimal similar item to be modified.

In some embodiments, initiating performance of one or more optimized resource allocation actions includes the apparatus being configured to cause resource record associated with the plurality of items to be modified. In some embodiments, a resource record is a record that indicates items associated with one or more facilities. In this regard, for example, resource record may be modified to remove an item, temporarily or permanently, from the resource record, such as when optimization data indicates that utilization of a target item in place of optimal similar item improves resource allocation or utilization of optimal similar item in place of target item improves resource allocation. In some embodiments, modifying an item resource record to remove an item may include causing, by the apparatus 200, of signals, transmission, and/or the like to a third-party system, such as a supplier system to cancel an order for the removed item or temporarily hold supply of the item.

In some embodiments, initiating performance of one or more optimized resource allocation actions includes generating, by the apparatus 200, item comparison report. In some embodiments, item comparison report is a report that provides a comparison between two or more items. In some embodiments, the item comparison report may be in a tabular format. In some embodiments, the item comparison report may include one or more images associated with the two or more items being compared. In some embodiments, initiating performance of one or more optimized resource allocation actions may include causing the item and related item comparison report to be provided on the resource allocation optimization interface component 402.

### CONCLUSION

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user’s client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
identifying, by one or more processors, resource data associated with a plurality of items;
generating, by the one or more processors, item similarity prediction data based on the resource data by applying the resource data to an item matching machine learning model, wherein the item similarity prediction data comprises at least one predicted similar items subset from the plurality of items, and wherein the at least one predicted similar items subset comprises at least one target item from the plurality of items and one or more similar items from the plurality of items;
identifying, by the one or more processors, item feature data associated with the at least one predicted similar items subset via one or more external sources;
generating, by the one or more processors, based on the item similarity prediction data and the item feature data, optimization data by analyzing the item similarity prediction data with respect to the item feature data, wherein the optimization data comprises an optimal similar item selected from the one or more similar items; and
initiating, by the one or more processors, performance of one or more optimized resource allocation actions in response to generation of the optimization data.

2. The computer-implemented method of claim 1, wherein at least one of the plurality of items are associated with a plurality of facility locations, wherein the at least one target item is associated with a first facility location from the plurality of facility locations and the optimal similar item is associated with a second facility from the plurality of facility locations.

3. The computer-implemented method of claim 1, wherein:
the at least one target item is associated with first item utilization status; and
the optimal similar item is associated with second item utilization status.

4. The computer-implemented method of claim 1, wherein generating the optimization data comprises applying the item feature data and the item similarity prediction data to a resource allocation optimization machine learning model.

5. The computer-implemented method of claim 1, wherein the item feature data comprises one or more of (i) technical characteristics, (ii) demand data, or (ii) obsolescence data.

6. The computer-implemented method of claim 1, wherein applying the resource data to the item matching machine learning model comprises:
inputting the resource data to the item matching machine learning model, wherein the item matching machine learning model is configured to perform fuzzy similarity-based matching operation on the resource data to generate the resource data; and
obtaining the item similarity prediction data from the item matching machine learning model.

7. The computer-implemented method of claim 1, wherein initiating the performance of the one or more optimized resource allocation actions comprises:
causing item design data associated with a related item that includes the optimal similar item to be modified.

8. The computer-implemented method of claim 7, wherein modifying the item design data includes replacing the optimal similar item with the at least one target item in the item design data.

9. The computer-implemented method of claim 1, wherein initiating the performance of the one or more optimized resource allocation actions comprises generating a resource allocation optimization interface component, wherein the resource allocation optimization interface component comprises one or more of data associated with the at least one target item and the optimal similar item.

10. An apparatus comprising memory and one or more processors communicatively coupled to the memory, the one or more processors configured to:
identify resource data associated with a plurality of items;
generate item similarity prediction data based on the resource data by applying the resource data to an item matching machine learning model, wherein the item similarity prediction data comprises at least one predicted similar items subset from the plurality of items, and wherein the at least one predicted similar items subset comprises at least one target item from the plurality of items and one or more similar items from the plurality of items;
identify item feature data associated with the at least one predicted similar items subset via one or more external sources;
generate based on the item similarity prediction data and the item feature data, optimization data by analyzing the item similarity prediction data with respect to the item feature data, wherein the optimization data comprises an optimal similar item selected from the one or more similar items; and
initiate performance of one or more optimized resource allocation actions in response to generation of the optimization data.

11. The apparatus of claim 10, wherein at least one of the plurality of items are associated with a plurality of facility locations, wherein the at least one target item is associated with a first facility location from the plurality of facility locations and the optimal similar item is associated with a second facility from the plurality of facility locations.

12. The apparatus of claim 10, wherein:
the at least one target item is associated with first item utilization status; and
the optimal similar item is associated with second item utilization status.

13. The apparatus of claim 10, wherein generating the optimization data comprises applying the item feature data and the item similarity prediction data to a resource allocation optimization machine learning model.

14. The apparatus of claim 10, wherein the item feature data comprises one or more of (i) technical characteristics, (ii) demand data, or (ii) obsolescence data.

15. The apparatus of claim 10, wherein applying the resource data to the item matching machine learning model comprises:
inputting the resource data to the item matching machine learning model, wherein the item matching machine learning model is configured to perform fuzzy similarity-based matching operation on the resource data to generate the resource data; and
obtaining the item similarity prediction data from the item matching machine learning model.

16. The apparatus of claim 10, wherein initiating performance of the one or more optimized resource allocation actions comprises:
causing item design data associated with a related item that includes the at least one target item to be modified.

17. The apparatus of claim 16, wherein modifying the item design data includes replacing the at least one target item with the optimal similar item in the item design data.

18. The apparatus of claim 10, wherein initiating performance of the one or more optimized resource allocation actions comprises generating a resource allocation optimization interface component, wherein the resource allocation optimization interface component comprises one or more of data associated with the at least one target item and the optimal similar item.

19. At least one non-transitory computer-readable storage medium having computer coded instructions configured to, when executed by at least one processor:
identify resource data associated with a plurality of items;
generate item similarity prediction data based on the resource data by applying the resource data to an item matching machine learning model, wherein the item similarity prediction data comprises at least one predicted similar items subset from the plurality of items, and wherein the at least one predicted similar items subset comprises at least one target item from the plurality of items and one or more similar items from the plurality of items;
identify item feature data associated with the at least one predicted similar items subset via one or more external sources;
generate based on the item similarity prediction data and the item feature data, optimization data by analyzing the item similarity prediction data with respect to the item feature data, wherein the optimization data comprises an optimal similar item selected from the one or more similar items; and
initiate performance of one or more optimized resource allocation actions in response to generation of the optimization data.

20. The at least one non-transitory computer-readable storage medium of claim 19, wherein at least one of the plurality of items are associated with a plurality of facility locations, wherein the at least one target item is associated with a first facility location from the plurality of facility locations and the optimal similar item is associated with a second facility from the plurality of facility locations.
